(19) United States
(12) Patent Application Publication
(10) Pub. No.: US 2013/0198258 A1
(43) Pub. Date: Aug. 1, 2013

(54) DATABASE IMPROVEMENT SYSTEM

(71) Applicants: Casimer M. DeCusatis, Poughkeepsie, NY (US); Rajaram B. Krishnamurthy, Wappingers Falls, NY (US); Anuradha Rao, Hopewell Junction, NY (US); Naseer Siddique, Poughkeepsie, NY (US)

(72) Inventors: Casimer M. DeCusatis, Poughkeepsie, NY (US); Rajaram B. Krishnamurthy, Wappingers Falls, NY (US); Anuradha Rao, Hopewell Junction, NY (US); Naseer Siddique, Poughkeepsie, NY (US)

(73) Assignee: International Business Machines Corporation, Armonk, NY (US)

(21) Appl. No.: 13/360,717

(22) Filed: Jan. 28, 2012

(51) Int. Cl. G06F 15/16

(52) U.S. Cl. 709/203

(57) ABSTRACT

An improved database system may include a root-server including a computer processor. The system may also include a segment-server including a computer processor, the segment-server to store data based upon the data's frequency of use by a client who is closer to the segment-server than the root-server and any other segment-server in the system, and the data stored is at least write data. The system may further include a consistency unit to update the root-server based upon data stored by the segment-server and client.

### BACKGROUND

The invention relates to the field of computer networking, and, more particularly, to database systems.

Data integration in product lifecycle management systems is important for end to end business process execution. Service-oriented architecture (“SOA”) technology may be used to integrate data from multiple disparate data sources in a single portal graphic user interface (“GUI”).

### SUMMARY

According to one embodiment of the invention, an improved database system may include a root-server including a computer processor. The system may also include a segment-server including a computer processor, the segment-server to store data based upon the data's frequency of use by a client who is closer to the segment-server than the root-server and any other segment-server in the system, and the data stored is at least write data. The system may further include a consistency unit to update the root-server based upon data stored by the segment-server and client.

The data stored may include read data, and the write data includes at least one of updates, deletes, and additions to the data. The consistency unit may update at least one of inheritance relationships and polymorphic relationships in the stored data.

The system may also include a client that gets pre-loaded with a portion of stored data based upon the frequency of use by the client to improve the client performance. The segment-server performance may improve based upon at least one of a client selected usage scenario and a usage heuristic.

The system may further include a manager to control client membership to the system and message routing within the system. The segment-server may include virtual cache containers based upon the client and a share flag carried by the data.

The virtual cache containers may be added and/or subtracted for load balancing. The root-server may load balance between a plurality of segment-servers by having the segment-servers' frequently accessed data replicated into the virtual cache containers and loaded on other segment-servers.

The data may be segmented across a plurality of segment-servers based upon at least one of volume and size of the data. The root-server may co-locate part of the data onto a segment-server when a timing threshold is exceeded. The segment-server may include an update table of client caches sent to the root-server which updates the segment-server based upon the client caches.

Another aspect of the invention is a method for improving a database system. The method may include storing data with a segment-server including a computer processor based upon the data's frequency of use by a client who is closer to the segment-server than a root-server and any other segment-server in a system, and the data stored is at least write data. The method may also include updating the root-server based upon data stored by the segment-server and client with a consistency unit.

The method may further include updating inheritance relationships and/or polymorphic relationships in the stored data with the consistency unit. The method may additionally include pre-loading a client with a portion of stored data based upon the frequency of use by the client to improve the client performance.

The method may also include improving the segment-server performance base upon at least one of a client selected usage scenario and a usage heuristic. The method may further include controlling client membership to the system and message routing within the system with a manager. The method may additionally comprise including virtual cache containers based upon the client and a share flag carried by the data at the segment-server.

Another aspect of the invention is a computer readable program codes coupled to tangible media to improve a database system. The computer readable program codes may be configured to cause the program to store data with a segment-server including a computer processor based upon the data's frequency of use by a client who is closer to the segment-server than a root-server and any other segment-server in a system, and the data stored is at least write data. The computer readable program codes may also update the root-server based upon data stored by the segment-server and client with a consistency unit to.

### BRIEF DESCRIPTION OF THE DRAWINGS

FIG. 1 is a block diagram illustrating a database improvement system in accordance with the invention.

FIG. 2 is a flowchart illustrating method aspects for improving a database system according to the invention.

FIG. 3 is a flowchart illustrating method aspects for improving a database system according to the method of FIG. 2.

FIG. 4 is a flowchart illustrating method aspects for improving a database system according to the method of FIG. 2.

FIG. 5 is a flowchart illustrating method aspects for improving a database system according to the method of FIG. 2.

FIG. 6 is a flowchart illustrating method aspects for improving a database system according to the method of FIG. 2.

FIG. 7 is a flowchart illustrating method aspects for improving a database system according to the method of FIG. 2.

FIG. 8 is a chart illustrating SOA segmented data structure in accordance with the invention.

FIG. 9 is a block diagram illustrating an exemplary physical layout of servers in accordance with the invention.

FIG. 10 is a chart illustrating an alternative SOA segmented data structure in accordance with the invention.

FIG. 11 illustrates a cache backbone structure in accordance with the invention.

FIG. 12 illustrates data structures in accordance with the invention.

### DETAILED DESCRIPTION

The invention will now be described more fully hereinafter with reference to the accompanying drawings, in which preferred embodiments of the invention are shown. Like numbers refer to like elements throughout, and like numbers with letter suffixes are used to identify similar parts in a single embodiment.

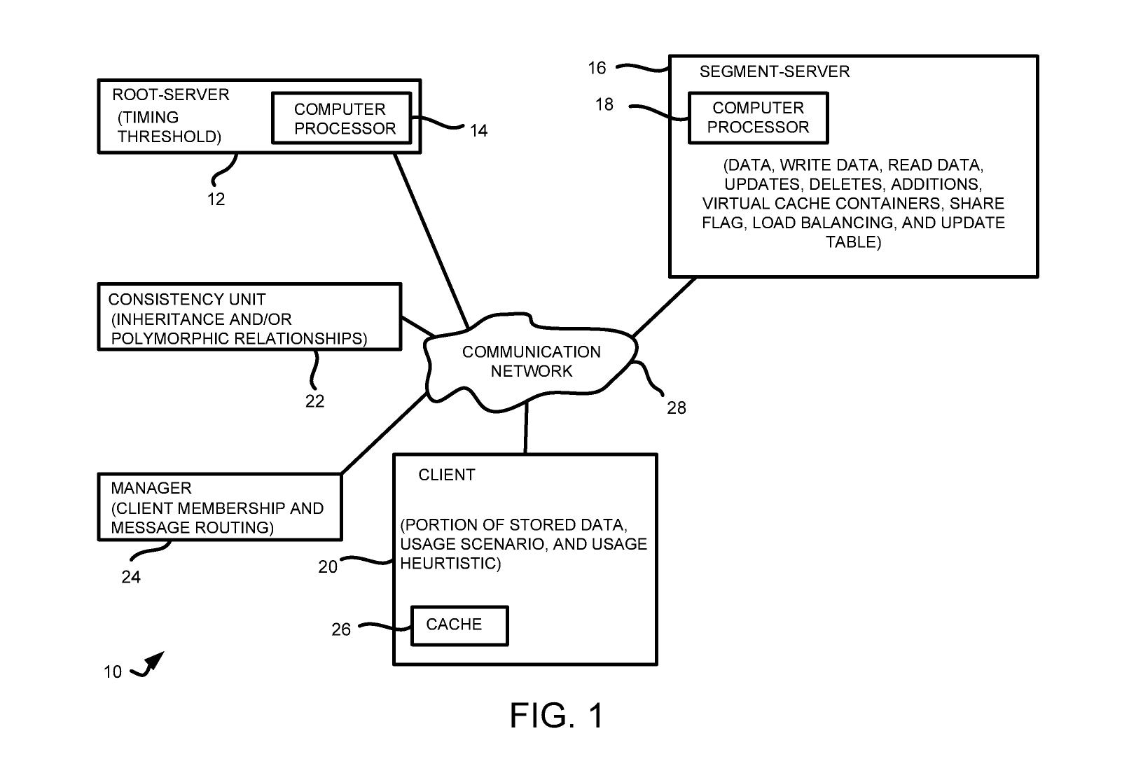

With reference now to FIG. 1, a database improvement system 10 is initially described. In an embodiment, the system 10 includes a root-server 12 including a computer processor 14. The system 10 may include any number of root-servers 12 and computer processors 14.

The system 10 also includes a segment-server 16 including a computer processor 18. The system 10 may include any number of segment-servers 16 and computer processors 18.

The segment-server 16 stores data based upon the data's frequency of use by a client 20 who is closer to the segment-server than the root-server and any other segment-server in the system, and the data stored is at least write data. The system 10 may include any number of clients 20.

The system 10 further includes a consistency unit 22 to update the root-server 12 based upon data stored by the segment-server 16 and client 20. The components of system 10 are connected by a communications network 28 as will be appreciated by those of skill in the art.

In one embodiment, the data stored may include read data, and the write data includes at least one of updates, deletes, and additions to the data. In another embodiment, the consistency unit 22 updates data based on inheritance relationships and/or polymorphic relationships in the stored data.

In one embodiment, the system 10 also includes a client 20 that gets pre-loaded with a portion of stored data based upon the frequency of use by the client to improve the client's performance. In another embodiment, the segment-server's 16 performance improves base upon the client's 20 selected usage scenario and/or a usage heuristic.

In one embodiment, the system 10 further includes a manager 24 to control client 20 membership to the system and message routing within the system. In another embodiment, the segment-server 16 include a virtual cache container based upon the client 20 and a share flag carried by the data. The system 10 may include any number of virtual cache containers.

In one embodiment, the virtual cache containers can be added and/or subtracted for load balancing. In another embodiment, the root-server 12 load balances between a plurality of segment-servers 16 by having the segment-servers' frequently accessed data replicated into the virtual cache containers and loaded on other segment-servers.

In one embodiment, the data is segmented across a plurality of segment-servers 16 based upon volume and/or size of the data. In another embodiment, the root-server 12 co-locates part of the data onto a segment-server 16 when a timing threshold is exceeded. In another embodiment, the segment-server 16 includes an update table of client cache 26 sent to the root-server 12 which updates the segment-server based upon the client cache. The system 10 may include any number of client cache 26.

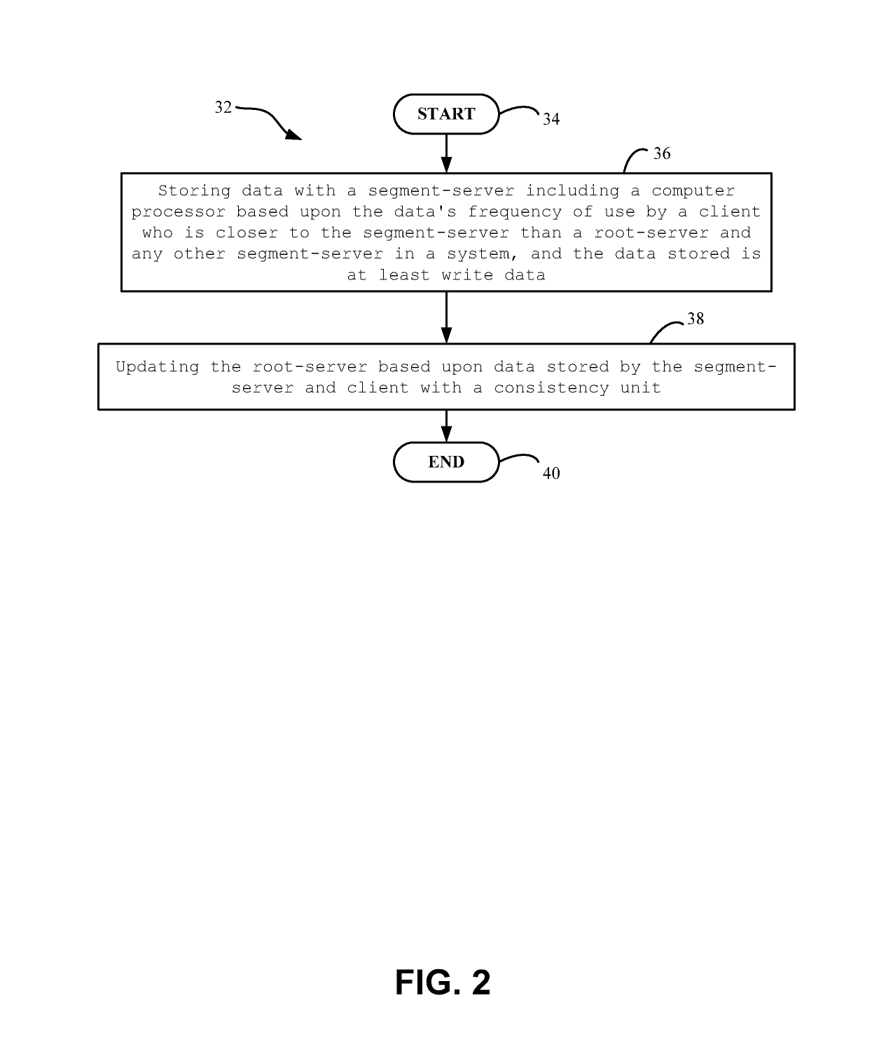

Another aspect of the invention is a method for improving a database system, which is now described with reference to flowchart 32 of FIG. 2. The method begins at Block 34 and may include storing data with a segment-server including a computer processor based upon the data's frequency of use by a client who is closer to the segment-server than a root-server and any other segment-server in a system, and the data stored is at least write data at Block 36. The method may also include updating the root-server based upon data stored by the segment-server and client with a consistency unit at Block 38. The method ends at Block 40.

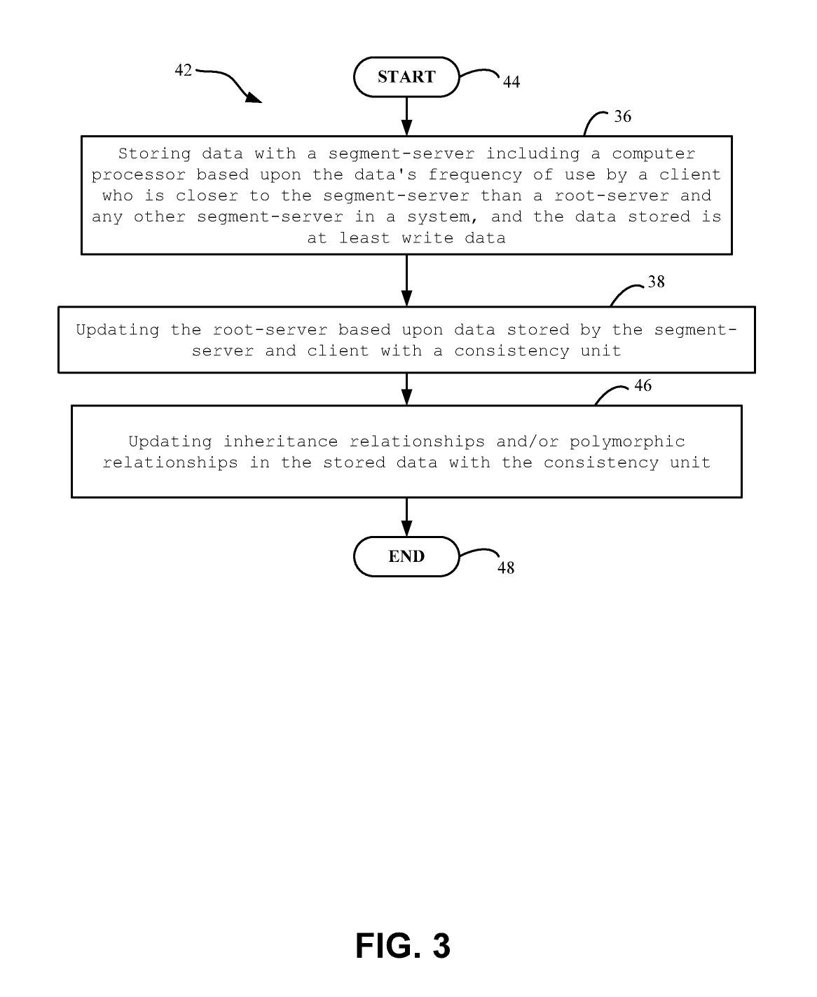

In another method embodiment, which is now described with reference to flowchart 42 of FIG. 3, the method begins at Block 44. The method may include the steps of FIG. 2 at Blocks 36 and 38. The method may further include updating data based on inheritance relationships and/or polymorphic relationships in the stored data with the consistency unit at Block 46. The method ends at Block 48.

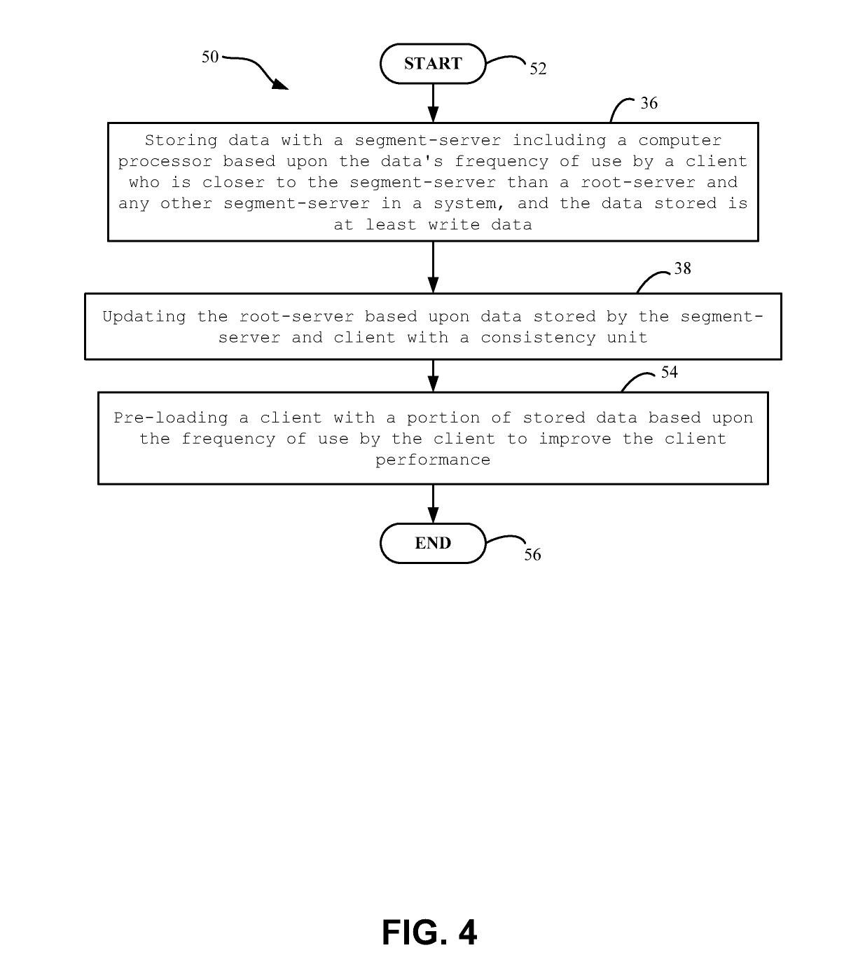

In another method embodiment, which is now described with reference to flowchart 50 of FIG. 4, the method begins at Block 52. The method may include the steps of FIG. 2 at Blocks 36 and 38. The method may additionally include pre-loading a client with a portion of stored data based upon the frequency of use by the client to improve the client performance at Block 54. The method ends at Block 56.

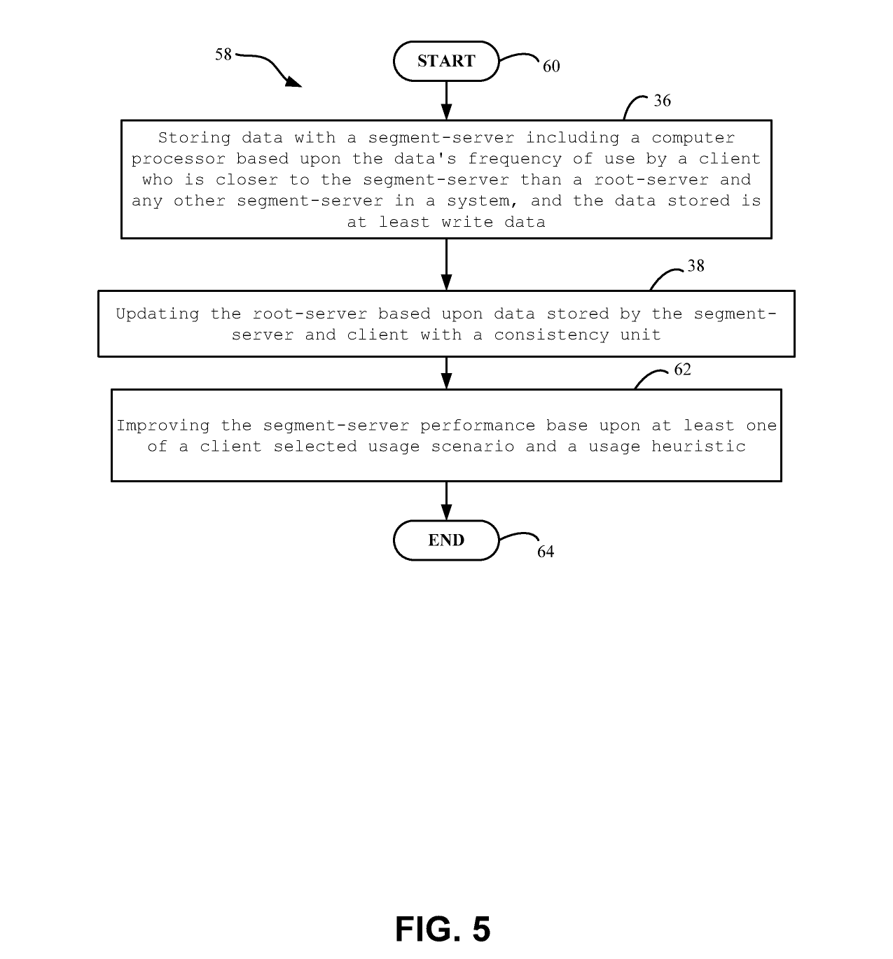

In another method embodiment, which is now described with reference to flowchart 58 of FIG. 5, the method begins at Block 60. The method may include the steps of FIG. 2 at Blocks 36 and 38. The method may also include improving the segment-server performance base upon at least one of a client selected usage scenario and a usage heuristic at Block 62. The method ends at Block 64.

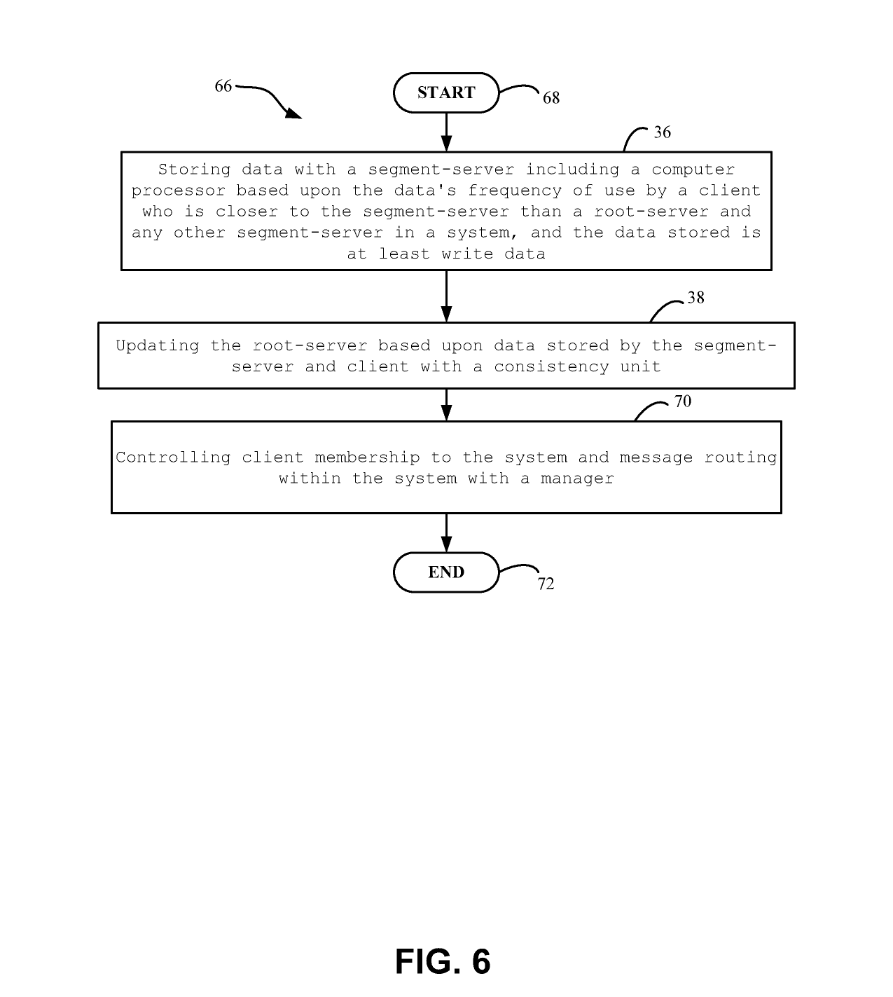

In another method embodiment, which is now described with reference to flowchart 66 of FIG. 6, the method begins at Block 68. The method may include the steps of FIG. 2 at Blocks 36 and 38. The method may further include controlling client membership to the system and message routing within the system with a manager at Block 70. The method ends at Block 72.

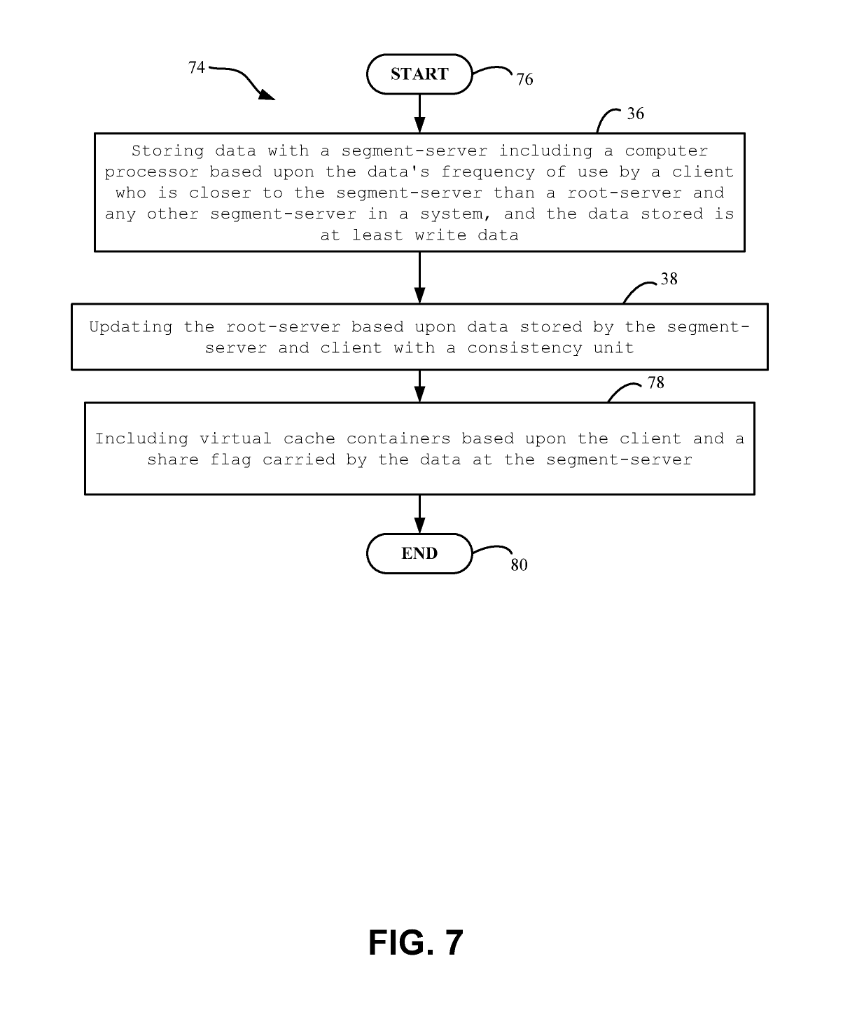

In another method embodiment, which is now described with reference to flowchart 74 of FIG. 7, the method begins at Block 76. The method may include the steps of FIG. 2 at Blocks 36 and 38. The method may additionally comprise including virtual cache containers based upon the client and a share flag carried by the data at the segment-server at Block 78. The method ends at Block 80.

Another aspect of the invention is a computer readable program codes coupled to tangible media to improve a database system 10. The computer readable program codes may be configured to cause the program to store data with a segment-server 16 including a computer processor 18 based upon the data's frequency of use by a client 20 who is closer to the segment-server than a root-server 12 and any other segment-server in the system, and the data stored is at least write data. The computer readable program codes may also update the root-server 12 based upon data stored by the segment-server 16 and client 20 with a consistency unit 22.

In view of the foregoing, the system 10 provides an improved database system. For example, while it is very convenient to search, read and edit data from different data sources in a single GUI, the performance of these operations is impacted due to data source location, user geographies etc. Users in geographies away from the data source geography experience performance issues. Performance is especially impacted when edits (Data load, modifications, inserts, and deletes) are executed. This is because time is spent in going to the root server for each search and edit, and commit/update. Normally web page caching improves performance slightly. But this also means certain user search pattern history has to be built up over a period of time. This does not result in improved performance for new users and new search/edit scenarios.

System 10 describes how caching of data structure, using a segmented scheme on a cache backbone can be implemented to improve performance and user productivity especially when data source and users are in different geographies. The idea is to cache frequently used data structures (partial or whole) in segment-servers 16. Segment-servers 16 can be pre-loaded with whole data structure or parts of data structure determined by access control, security, and privacy. In addition, a scheme of segmented caching can be used.

System 10 uses a segmented scheme with the cache backbone by slicing the data structure and placing it on SOA cache backbone. Data Consistency is maintained by an invalidate protocol and update Protocol during edits. This type of caching expedites search and edit times enhancing performance and productivity.

The following paragraphs explain how performance can be improved especially in edit execution on a SOA portal using segmented scheme with cache backbone. System 10 caches frequently used data structures in segment-servers 16. System 10 also pre-loads segment-servers 16 with the whole data structure or parts of data structure—determined by access control, security, and privacy.

System 10 segmented caching scheme on Cache backbone provides the complete data structure in the root-server 14 of the cache backbone. The data structure is sliced and placed on an SOA cache backbone. Child servers of the cache backbone contain portions or segments of data structure and clients are directed to appropriate cache.

The cache backbone is constructed by choosing a set of cache servers with the root cache server. The root cache server can be an SOA server. Other servers contain segments of the main SOA server. Child servers can also choose to store the whole master data structure.

For improved load balancing, root data structure may be: child segment 1+child segment 2+child segment 3. In one embodiment, there should be minimal overlap between each segment. In another embodiment, each segment should be mutually exclusive for optimal load balancing.

The consistency is maintained by using a monolithic cache technique where each segment cache functions as the central cache structure of the monolithic technique and a combination of invalidate and update protocols. See, for example, co-pending U.S. non-provisional patent application Ser. No. 12/621,189, titled “ADAPTIVE CACHING OF DATA” and filed Nov. 18, 2009, which is incorporated herein by reference in its entirety. In one embodiment, each segment server updates the root server after its own update is complete.

How is overlap between segment servers handled (overlap in segments)? Overlapped data structure segments are recorded in segment caches. When overlapped data structure segment updates are uncovered, the overlapping segment servers and root server are both updated using an invalidate or update protocol.

Consistency can be maintained (Monolithic scheme) using an invalidate protocol. A client invalidates relevant data structure segments of all client caches sharing the same data and updates server cache when data structure write is complete. When clients read invalidated segments, they will access the relevant data structure segments from the server.

System 10 updates all client caches and server cache. System 10 cross references to invalidate/update protocol for the Monolithic scheme. The Invalidate/Update message complexity is O(N) if one sender sends messages to N−1 other receivers. Instead, a Message tree (variable degree) is formulated using proximity of nodes. Nodes in proximity form sub-cluster. The algorithm strives to maximize degree of tree. Each node cluster elects a root (R). Node of originating (S) invalidation sends multicast to root (R) of all clusters. R multicasts to all child nodes of cluster.

After receiving Acknowledgement (ACKs) from peer nodes, each R sends cluster-level ACKs by aggregation. These ACKs can also be individually pipelined. “Best-Effort” scheme does not wait for ACKs. System 10 finds optimal tree structure based on membership of nodes. One to many results in large number of messages, but best latency. Tree based division results in low message count but probably at the expense of higher latency due to increased number of intermediate stages.

In one embodiment, the optimal tree structure includes group or cluster nodes (C) based on geographic proximity and/or network distance. In this case, maximize C, elect R for each cluster, and message count will be proportional to (log_{C}N).

System 10 includes SOA pattern (for hierarchically organized information) with coordinated client-side and server-side operation. Client usage is used to drive re-arrangement of initially cached information (based on business role and geography). Client usage drives segmentation.

System 10 caches (or pre-fetches) frequently used data structures (partial or whole) from either single or multiple disparate data sources (masters) in one or more intermediate segment servers (children) based on access control, business role, behavioral use patterns, and geographic location of users. System 10 also maintains consistency between child and master data structures using an invalidate and/or update protocol.

System 10 includes an adaptive cache backbone structure. The adaptive cache backbone structure includes traditional segmentation, affinitizing users (rearrangement), prioritizing based on business role, fine grain locking based on business role, inter cache protocol for data structure overlap management, and has a set of physical servers.

The system 10 slices data structure in virtual cache containers. In one embodiment, (Fair) strict load balancing, uses the relationship between data structure nodes and number of users to divide users amongst segments. In another embodiment, (Greedy Approach), slicing is based on number of users/business role/geography and their relationship with a segment of the data structure. In other words, the idea is to cache data that is most likely to be used frequently based on business role and geography.

In one embodiment, a given number of virtual cache containers are instantiated based on static user information. When the load increases, virtual cache containers can be replicated and placed on separate physical servers for load balancing. When load changes, virtual cache containers are deleted or “idled” in the system. The adaptability of the cache backbone structure is based on the ability to adapt from a given number of users in the system known a priori to a variable number of users in the system that come online as the system is in operation

The slicing of the data structure and mapping to the physical servers is a key novelty. Trees can be sliced so that sub-trees have an equal number of possible users. Sub-trees and objects within the subtrees can be replicated to handle additional load.

The segmentation also handles overlap between data structures. Some of data structures have no overlap like a linked list or a list with front and back pointers.

System 10 provides SOA pattern (for hierarchically organized information) with coordinated client-side and server-side operation. Client usage is used to drive re-arrangement of initially cached information (based on business role and geography). Cache directory entries are updated on the client in response to movement of cached segments from server to server. This reduces the need for forwarding of requests from the home server to the current cached location. Clients can use their directory entries to find needed data. Users are affinitized to cached segments closest to them with directory entries updated directly on the clients. Clients may be preloaded with cached data (at the beginning of a business day) based on their recent usage of cached segments.

System 10 provides an adaptive cache backbone structure. This helps map a data structure or relationship between objects to a set of segment servers in an efficient manner. The adaptive cache backbone structure works in the following manner. User affinitization is completed based on profiling cache access. The salient features include traditional segmentation (profile step), affinitize users (rearrangement), prioritization based on business role, fine grain locking based on business role and inter cache protocol for overlaps between segment server.

The segmentation also handles overlap between data structures. Some of data structures have no overlap like a linked list or a list with front and back pointers.

System 10 pre-load caches on thin clients and rich clients based on adaptive cache backbone structure.

System 10 provides at least two SOA patterns that use caching at various levels. System 10 first devised this for an engineering parts database where parts have a hierarchical relationship that can be structured in a tree with variable degree. System 10 then generalized this for any set of objects and data structures.

System 10 caching in these patterns is fundamentally different from web caching because these SOA patterns supports writes—updates, deletes, and additions of data parts in addition to reads of data. These operations ensure that all caches are consistent after they complete.

System 10 SOA caching is fundamentally different from filesystem caching because parts in an engineering database may have inheritance and polymorphic relationships between each other. For example, a fan blower in a System p attached using a four screw base and a fan blower in a System z used without the screw base. If one makes attribute updates to the fan blower then both fan blowers must be updated although one part inherits properties from the other. The SOA pattern may also support custom/manual inheritance and the caching policies must be able to support this.

System 10 is fundamentally different from caching in prior art because it uses behavioral use patterns to statically instantiate a cache structure and then varies this dynamically (number of cache instances and content of cache (by prefetching)) based on user and system load to achieve system efficiency and user productivity. Client caches in our system are smart. They configure based on static cache usage scenarios declared by the user, learn from history and also use prefetching to improve performance. System 10 uses relationship between objects in a data structure to help cache and prefetching efficiency. While usage patterns are easy to “learn” in a corporate intranet, they can be generalized by having users participate in a social network.

System 10 pre-loads rich client caches with data from server based on business role and geography. In essence, the pre-loading loads only relevant data based on the users of the client and filters away the rest. System 10 studies user behavior to pre-load cache. System 10 prefetches from master database based on user cache access behavior. System 10 prefetch policies are dependent on the structure of data used. System 10 has prefetch policies for the hierarchical tree structure and also have policies for linked list structures. Thin Clients are attached to a “departmental cache” which could be a mid-range server.

System 10 provides an adaptive tree with variable degree. A red-black tree is a binary tree (it has a static degree of two and the degree does not change). The tree structure of system 10 changes its degree based on client membership and the need for optimal message routing. The tree structure in this disclosure is used to manage membership of clients as they attach and detach from the system. The tree structure is used to route messages. The tree structure can change its degree from one value to other—here in lies the adaptivity of the tree.

System 10 does not use the adaptive tree in the sense of a red-black binary tree for sorting, searching or retrieval. The adaptive tree of system 10 is used for routing messages in an optimal manner. Tree adaptivity is useful because it helps construct “wide trees” and “tall trees”. “Wide Trees” are useful to aggregate invalidate messages. “Tall trees” are useful to aggregate updates to objects. Geographic proximity and network distance is used to cluster and change tall trees to wide trees.

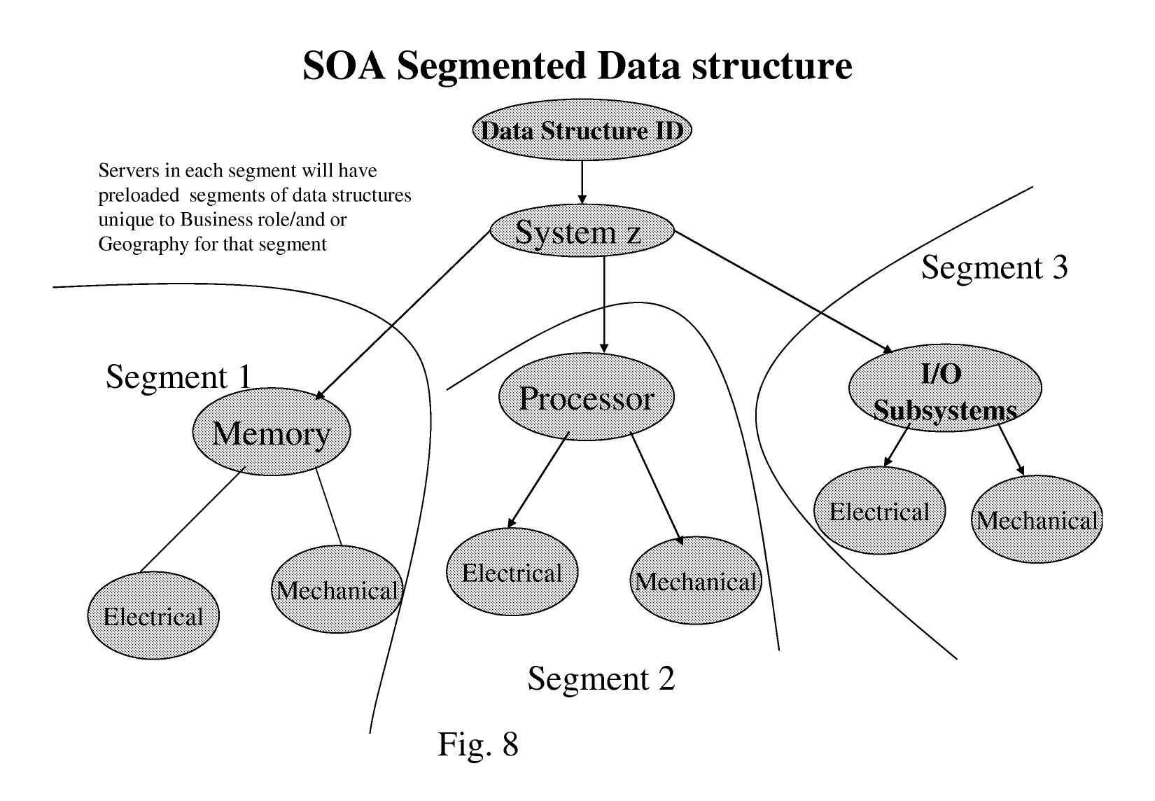

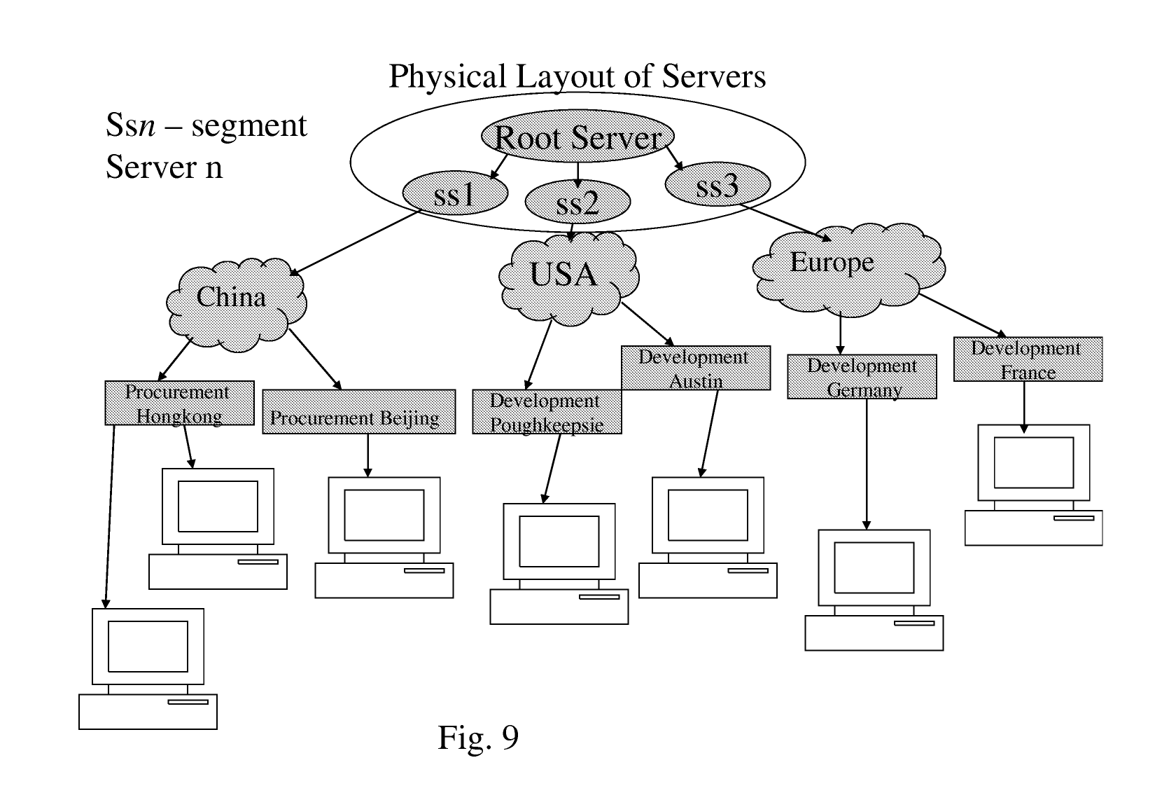

FIG. 8 shows an example data structure that is stored on the root-server 12 of FIG. 9. It will be understood that a single business role may exist across geographies.

Geography servers may exist in the clouds shown in FIG. 9 corresponding to China, USA and Europe. Segment servers may be co-located with the root server in each datacenter or may be geographically dispersed. The interconnection network between root-servers 12 and segment-servers 16 is called the segment backbone. Any updates to segment-servers 16 data structures requires updates to the root-servers 12. These updates may be completed in lazy fashion if data structure nodes are known to be replicated and located at a single segment-servers 16. The root-servers 12 maintains a list of segment-servers 16 where data structure nodes are replicated and stored. The data structure in FIG. 8 is tagged with a share flag that can take one of these values—“geography based co-location”, “business role based co-location” or “business and geography based co-location”. Tagging a data structure with a share flag means that all nodes of the data structure are likely co-located on the same segment server(s) determined by geography or business role. Related data structures may be tagged similarly so that they may be co-located on segment servers for better efficiency.

Read, write, and update references to various nodes of the data structure is stored in a table on the root-servers 12 as references are made. Average response time for access or updates of various sections of the data structure is also stored in the table.

When load on the root-servers 12 exceeds a designer chosen threshold and response time exceeds the average time stored in the table, portions of the data structure shared across a business role and geography are replicated and co-located on segment-server 1 (for example). This is termed dynamic segmentation. Co-location helps updates to be shared rapidly since users in a business role or geography are likely to use the same portions of the data structure.

When the share flag is set to “business/geography” based co-location, a running total of resource utilization for each business role and geography is maintained in a table on the root server. Data structure nodes with the highest resource utilization for a given business role or geography are replicated and co-located on each segment server. These nodes may also be evenly distributed across multiple segment-servers 16. Each segment-server 16 is associated with a business role and geography. This information may be maintained in a front-end server to the datacenter or may be relayed to geography servers in FIG. 9 (China, Europe, USA). This allows requests to be relayed efficiently.

For example, the data structure in FIG. 8 is tagged with a geography based co-location flag value. Users in China access the “memory” subsection of the data structure and this may result in replication and deployment of the “memory” subsection on segment server 1 of FIG. 9. Similarly ss2 contains the “processor” subsection used by the USA geography and ss3 contains the “IO subsection” used by the Europe geography. Servers in each geography may cache portions of the data structure locally. Each user may also cache contents in its own client cache.

After the end of every session, client caches 26 are aggregated at geography servers and accesses outside segment server contents are tabulated (called “extraneous nodes”). This segment-server-update table is sent to the root-server 12 and the root server may augment each segment server with additional data structure nodes. This augmentation helps efficiency since at the start of the next session any requests to these “extraneous nodes” may be served directly by the segment-server 16 instead of the root-server 12.

When a data structure is being accessed simultaneously, accesses to segment-servers 16 outside its current contents may be served by a root-server 12. When these accesses become frequent, the root-server 12 may depute a segment-server 16 holding any of the contents to serve the data. When this happens, data structure nodes are co-located at a segment-server 16 in a “virtual cache container” which is a replicated set of data structure nodes. The virtual cache container is then moved to the segment-server 16 (surrogate server) making frequent requests, from the home server (the segment server that instantiates the contents of the virtual cache container). The home server may send automatic updates to the surrogate server to update the contents of the virtual cache containers.

In one embodiment, system 10 provides volume based segmentation and virtual cache containers. The data structure may be segmented into various segment-servers 16 evenly based on data volume/size. Such a scheme may be used when data structures exist as linked lists or doubly linked lists. When the root-server 12 notices uneven load utilization between segment-servers 16, segment servers with higher loads may have their frequently accessed contents to be replicated into cache containers and loaded on other segment servers. This allows load to be balanced evenly across segment-servers 16.

When load on the root-server 12 exceeds a designer chosen threshold and response time exceeds the average time stored in the table, portions of the data structure shared across a business role and geography are replicated and co-located on segment server 1 (for example). This is termed dynamic segmentation.

Co-location helps updates to be shared rapidly since users in a business role or geography are likely to use the same portions of the data structure. When the share flag is set to “business/geography” based co-location, a running total of resource utilization for each business role and geography is maintained in a table on the root-server 12. Data structure nodes with the highest resource utilization are replicated and co-located on each segment-server 16. These nodes may also be evenly distributed across multiple segment-servers 16. Each segment-server 16 is associated with a business role and geography. This information may be maintained in a front-end server to the datacenter or may be relayed to geography servers in FIG. 9 (China, Europe, USA). This allows requests to relay efficiently.

After the end of every session, client caches 26 are aggregated at geography servers and accesses outside segment-server 16 contents are tabulated (called “extraneous nodes”). This segment-server-update table is sent to the root-server 12 and the root server may augment each segment-server 16 with additional data structure nodes. This augmentation helps efficiency since at the start of the next session any requests to these “extraneous nodes” may be served directly by the segment-server 16 instead of the root-server 12.

System 10 segments the data/data structures unique to a set of users based on Business role and geography. System 10 populates the local segment-server 16 with the segmented data structure/meta data. System 10 also maintains consistency between child and master data structures.

System 10 invalidates/updates message complexity is O(N) if one sender send messages to N−1 other receivers. The message tree (variable degree) is formulated using proximity of nodes. Nodes in proximity form sub-cluster. The algorithm strives to maximize degree of tree. Each node cluster elects a root (R). Node of originating (S) invalidation sends multicast to root (R) of all clusters. R multicasts to all child nodes of cluster.

After receiving ACKs from peer nodes, each R sends cluster-level ACK back to S. ACKs can also be pipelined by clustering. “Best-Effort” scheme does not wait for ACKs. System 10 finds optimal tree structure based on membership of nodes. One-to-many results in large number of messages, but best latency. Tree based division results in low message count, but probably at the expense of higher latency.

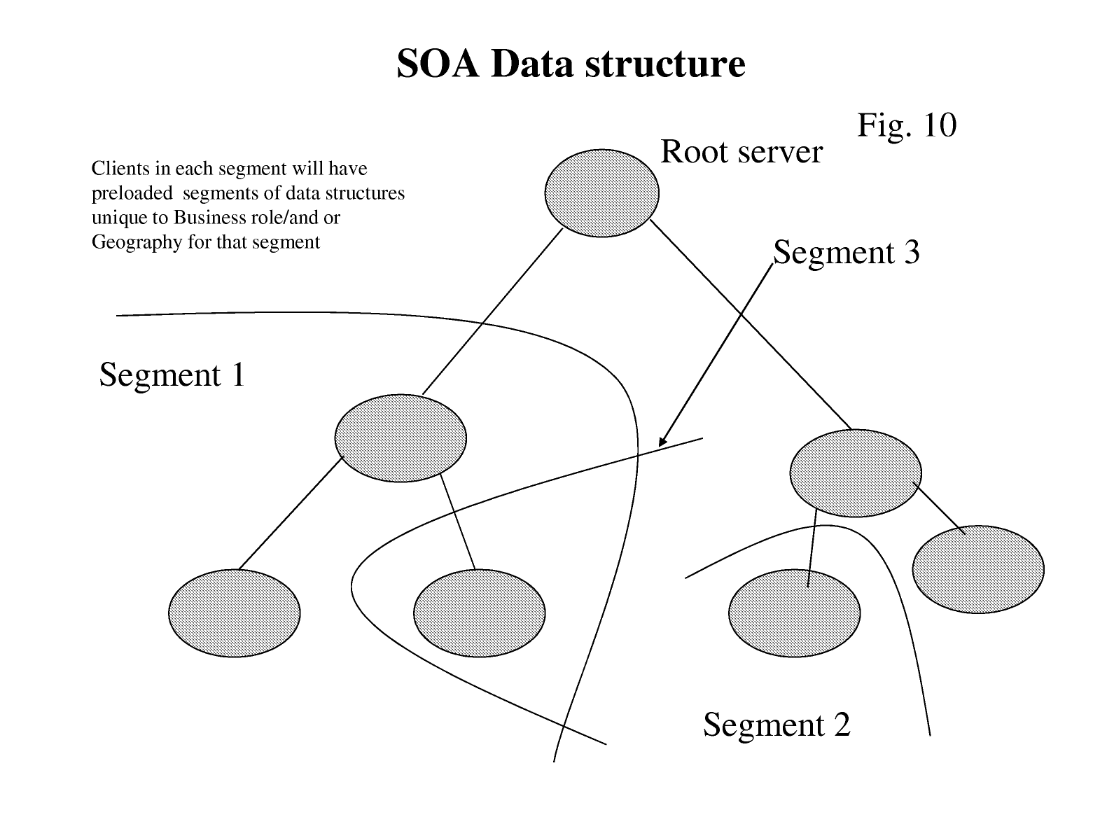

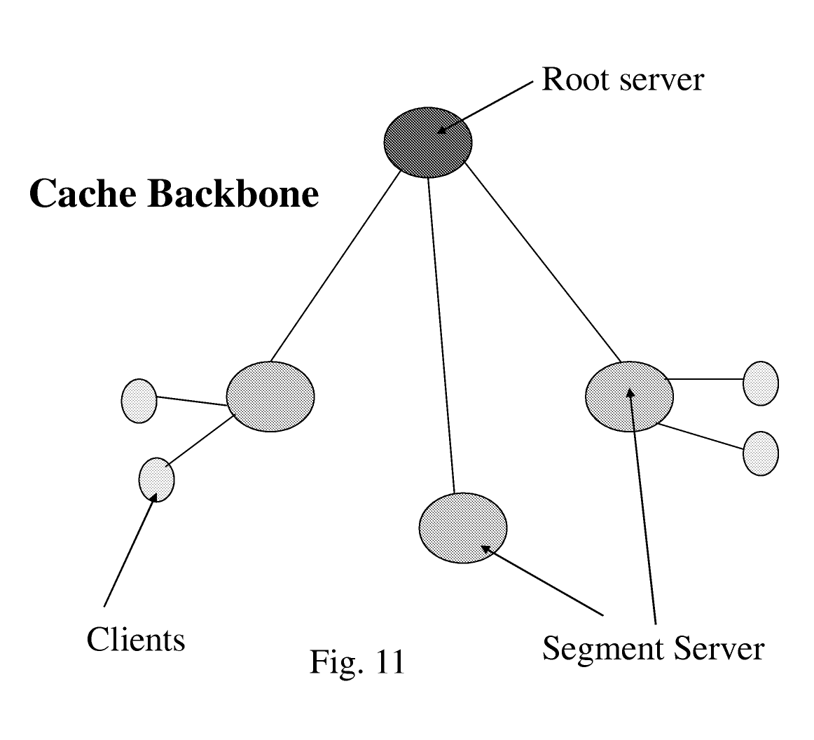

With reference to FIGS. 8-12, in one embodiment, system 10 is an Engineering Information Portal (EIP). System 10 is a portal based application that integrates data from multiple, disparate backend data sources (PM, eXplore, ERE, and/or the like).

In one embodiment, system 10 uses a single user interface to access all three databases with a single sign-on. In another embodiment, system 10 adapts to users roles and behavioral habits to present search and result views.

In one embodiment, system 10 facilitates one stop search for part information, enhances user experience and/or productivity. In another embodiment, system 10 is extensible to integration of future data sources. In another embodiment, system 10 uses SOA technology to simplify the IT landscape.

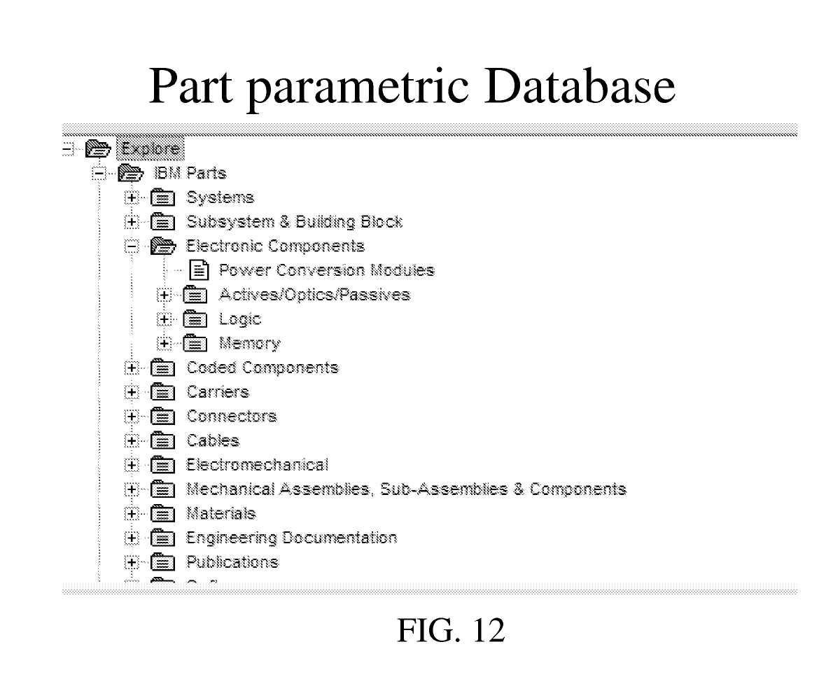

In one embodiment, each segmented sector of system 10 has data unique to a functional role, e.g. memory, I/O or processor, mechanical or electrical parts development, and/or the like. In one embodiment, data structure as exemplified in FIG. 12 is segmented and cached in individual virtual cache containers in each segment as illustrated in FIG. 8.

In one embodiment, the segmented sector of system 10 can also be based on the business role of the user, e.g. development, procurement, research, manufacturing, and/or the like. Such a segment based on business role may involve multiple geographies, e.g. Europe, China, USA, and/or the like, or a single geography.

In one embodiment, each segment in system 10 comprises a segment server (SSn). In another embodiment, data structure is segmented and cached in segment servers as illustrated in FIG. 9.

It should be noted that in some alternative implementations, the functions noted in a flowchart block may occur out of the order noted in the figures. For instance, two blocks shown in succession may, in fact, be executed substantially concurrently, or the blocks may sometimes be executed in the reverse order, depending upon the functionality involved because the flow diagrams depicted herein are just examples. There may be many variations to these diagrams or the steps (or operations) described therein without departing from the spirit of the invention. For example, the steps may be performed concurrently and/or in a different order, or steps may be added, deleted, and/or modified. All of these variations are considered a part of the claimed invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system comprising:
a root-server including a computer processor;
a segment-server including a computer processor, the segment-server to store data based upon the data's frequency of use by a client who is closer to the segment-server than the root-server and any other segment-server in the system, and the data stored is at least write data; and
a consistency unit to update the root-server based upon data stored by the segment-server and client.

2. The system of claim 1 wherein the data stored includes read data, and the write data includes at least one of updates, deletes, and additions to the data.

3. The system of claim 1 wherein the consistency unit updates at least one of inheritance relationships and polymorphic relationships in the stored data.

4. The system of claim 1 further comprising a client that gets pre-loaded with a portion of stored data based upon the frequency of use by the client to improve the client's performance.

5. The system of claim 1 wherein the segment-server's performance improves base upon at least one of the client's selected usage scenario and a usage heuristic.

6. The system of claim 1 further comprising a manager to control client membership to the system and message routing within the system.

7. The system of claim 1 wherein the segment-server includes a virtual cache container based upon the client and a share flag carried by the data.

8. The system of claim 7 wherein the virtual cache container is at least one added and subtracted for load balancing.

9. The system of claim 8 wherein the root-server load balances between a plurality of segment-servers by having the segment-servers' frequently accessed data replicated into the virtual cache container and loaded on other segment-servers.

10. The system of claim 1 wherein the data is segmented across a plurality of segment-servers based upon at least one of volume and size of the data.

11. The system of claim 1 wherein the root-server co-locates part of the data onto a segment-server when a timing threshold is exceeded.

12. The system of claim 1 wherein the segment-server includes an update table of a client cache sent to the root-server which updates the segment-server based upon the client cache.

13. A method comprising:
storing data with a segment-server including a computer processor based upon the data's frequency of use by a client who is closer to the segment-server than a root-server and any other segment-server in a system, and the data stored is at least write data; and
updating the root-server based upon data stored by the segment-server and client with a consistency unit to update the root-server based upon data stored by the segment-server and client.

14. The method of claim 13 further comprising updating at least one of inheritance relationships and polymorphic relationships in the stored data with the consistency unit.

15. The method of claim 13 further comprising pre-loading a client with a portion of stored data based upon the frequency of use by the client to improve the client performance.

16. The method of claim 13 further comprising improving the segment-server performance base upon at least one of a client selected usage scenario and a usage heuristic.

17. The method of claim 13 further comprising controlling client membership to the system and message routing within the system with a manager.

18. The method of claim 13 further comprising including a virtual cache container based upon the client and a share flag carried by the data at the segment-server.

19. A computer program product embodied in a tangible media comprising:
computer readable program codes coupled to the tangible media to improve database systems, the computer readable program codes configured to cause the program to:
store data with a segment-server including a computer processor based upon the data's frequency of use by a client who is closer to the segment-server than a root-server and any other segment-server in a system, and the data stored is at least write data; and
update the root-server based upon data stored by the segment-server and client with a consistency unit to update the root-server based upon data stored by the segment-server and client.

20. The computer program product of claim 19 further comprising program code configured to: update at least one of inheritance relationships and polymorphic relationships in the stored data with the consistency unit.

21. The computer program product of claim 19 further comprising program code configured to: pre-load a client with a portion of stored data based upon the frequency of use by the client to improve the client performance.

22. The computer program product of claim 19 further comprising program code configured to: improve the segment-server performance base upon at least one of a client selected usage scenario and a usage heuristic.

23. The computer program product of claim 19 further comprising program code configured to: control client membership to the system and message routing within the system with a manager.

24. The computer program product of claim 19 further comprising program code configured to: include a virtual cache container based upon the client and a share flag carried by the data at the segment-server.
